(19) United States
(12) Patent Application Publication
(10) Pub. No.: US 2002/0159773 A1
(43) Pub. Date: Oct. 31, 2002

(54) Driving mechanism

(76) Inventors: Takamitsu Kodama, Yaita-shi (JP); Hiroshi Watanabe, Osaka (JP)

Correspondence Address: BIRCH STEWART KOLASCH & BIRCH, PO BOX 747, FALLS CHURCH, VA, 22040-0747, US

(21) Appl. No.: 10/102,962

(22) Filed: Mar. 22, 2002

(30) Foreign Application Priority Data
Mar. 23, 2001 (JP) P2001-84240

(51) Int. Cl. G03B 17/00

(52) U.S. Cl. 396/419

(57) ABSTRACT

An object of the invention is to provide a driving mechanism of a simple structure capable of preventing transmission of vibration generated by a rotative driving source such as a motor to an object to be driven such as a camera. Driving the motor to rotate its output shaft causes a rotating member to rotate. Concurrently an elastic roller rotates and transmits a driving force to a force point section of a driven member. During such operation, since slight vibration generated by the motor is damped absorbed in the roller, the vibration transmitted to the driven member becomes substantially slighter. When the driving force is applied to a force point section the force point section is caused to swing, and concurrently the camera fixed to an action point section is caused to swing. Since transmission of vibration generated by the motor can be prevented, images taken by the camera will not shake.

### BACKGROUND OF THE INVENTION

1. Field of the Invention

The present invention relates to a driving mechanism for intermediating between an object to be driven such as a camera designed to change its position by swinging vertically and horizontally which camera is used in a video conference system and a rotative driving source such as a motor.

2. Description of the Related Art

FIG. 6 is a drawing showing a first prior art, and FIG. 7 a second prior art. In a posture driving mechanism of a camera 1 for recording moving images which camera is used for a video conference etc., motors 2, 12 are fixed to supporting bases 4, 14 with elastic vibroisolating materials 3, 13 placed therebetween, in order to prevent transmission of vibration generated by the motors 2, 12 that are the rotative driving source, to the camera 1.

In the first prior art of FIG. 6, rotation of a disc-shape rotating member 6 fixed to the output shaft 5 of the motor 2 causes a roller 7 attached to the rotating member 6 to swing an end of a driven lever 8 in one direction around a rigid body fulcrum shaft 9. Concurrently, the camera 1 fixed on the other end of the driven lever 8 is caused to rotate in the opposite direction around the rigid body fulcrum shaft 9. This is how the camera 1 swings.

However in the first prior art, since the motor 2 is fixed to the supporting base 4 with elastic vibroisolating materials 3 placed therebetween, the position of the motor 2 against the supporting base 4 is varied by the vibration of the motor 2 and a moment applied to the motor 2 by the roller 7 around the output shaft 5 when driving the motor 2. This will also change the position of the roller attached to the motor 2. In other words a variation of the position of the motor 2 leads to a variation of the driven lever 8, which consequently leads to a disadvantage that the camera 1 fixed to the driven lever 8 vibrates, thus finally causing images taken by the camera 1 to shake.

In the second prior art of FIG. 7, rotating a cam 10 rotatably attached to the supporting base 14 by the motor 12 causes a driven lever 18 provided with a roller 13 that contacts with the cam 10 to move vertically. By such vertical movement of the driven lever 18, the camera 1 rotatably attached to a rotative fulcrum shaft 19 of a fixed angle 11 is caused to swing. By converting a rotating motion of the motor 12 into a rectilinear motion of the driven lever 18 through the cam 10 as above, the vibration and shaking of the motor 12 can be kept from being transmitted to the camera 1. However, the second prior art also has a disadvantage that the structure is complicated, and therefore a high production cost is required while its production efficiency is low.

### SUMMARY OF THE INVENTION

In view of the fore going, an object of the present invention is to provide a driving mechanism of a simple structure capable of preventing transmission of vibration generated by a rotative driving source such as a motor to an object to be driven such as a camera.

The invention provides a driving mechanism for transmitting a rotative force of a rotative driving source for driving an object to be driven, comprising a supporting base; a rotating member that rotates relative to a rotation of an output shaft of the rotative driving source; an elastic body unit located at a position of the rotating member which position is not on a rotational axial line thereof; a driven member provided with a force point section with which the elastic body unit contacts, an action point section to which the object to be driven is attached, and a fulcrum section; and a supporting shaft unit for connecting the fulcrum section of the driven member with the supporting base so that the driven member can rotate.

The driving mechanism of the invention is characterized in that the elastic body unit is composed of a pin fixed to the rotating member generally in parallel with the rotational axial line of the rotating member, and an elastic roller rotatably attached to the pin around its axial line.

The driving mechanism of the invention is characterized in that the supporting shaft unit is elastic.

The driving mechanism of the invention further comprises energizing means for constantly energizing the driven member in one rotational direction.

The driving mechanism of the invention is characterized in that the force point section of the driven member is provided with a bore portion having an opening facing outside, and the roller of the elastic body unit is loosely inserted through the bore portion with a clearance therebetween.

The driving mechanism of the invention is characterized in that the object to be driven is a camera.

A basic structure, operation and advantage of the driving mechanism 32 according to the invention shall be described referring to FIG. 1. FIG. 1 is a drawing showing an example of the driving mechanism 32 of the invention. A camera 31 for recording moving images that is the object to be driven is applied a driving force through the driving mechanism of the invention 32 by a motor 33 that is the rotative driving source, so that the camera 31 can swing as shown by the arrows 34a and 34b. The driving mechanism 32 comprises a supporting base 41, a rotating member 35, an elastic body unit 36, a driven member 37, a supporting shaft unit 38 and means for energizing 39.

The motor 33 is fixed to the supporting base 41 with fastening components 42 having a high rigidity such as metallic bolts. Therefore a variation of the position of the motor 33 against the supporting base 41 can be prevented even when the motor 33 generates vibration. The rotating member 35 is caused to rotate in compliance with the rotative motion of the output shaft 40 of the motor 33. FIG. 1 shows a state where the output shaft 40 of the motor 33 and the rotating member 35 are coaxially mounted, however they do not necessarily have to be coaxially mounted as long as the rotating member 35 is designed to rotate in compliance with the rotation of the output shaft 40 of the motor 33.

The elastic body unit 36 is attached to the rotating member 35 at a position except on its rotational axial line 43. The elastic body unit 36 consists of a pin 44 fixed generally in parallel with the rotational axial line 43 and a roller 45 rotatably attached to the pin 44 around its axial line. The roller 45 consists of a roller main body 54 and an elastic bush 56 (hatching section of FIG. 1) surrounding the outer circumference of the roller main body 54.

The driven member 37 is provided with an action point section 46, fulcrum section 47 and force point section 48. At the fulcrum section 47, the driven member 37 is attached to the supporting base 41 with the supporting shaft unit 38 in such a manner that the driven member 37 can swing. The supporting shaft unit 38 consists of a shaft main body 55 and an elastic bush 56 surrounding the outer circumference of the shaft main body 55. Also, the camera 31 is fixed to the action point section 46 of the driven member 37. The force point section 48 is formed generally in U-shape with a bore portion 49 having an opening facing outside.

The bore portion 49 of the driven member 37 is formed in slightly greater dimensions than the diameter of the roller 45 of the elastic body unit 36, so that the roller 45 is loosely inserted through the bore portion 49 securing a clearance therebetween. Also the driven member 37 is constantly energized unidirectionally around the swinging axial line 51 by the energizing means 39. In the example of FIG. 1, the force point section 48 is constantly being pulled counterclockwise 50a around the swinging axial line 51, for example by a tension coil spring. Therefore the roller 45 of the elastic body unit 36 is constantly in contact with one of the inner walls of the bore portion 49.

The foregoing structure is operated as follows. When driving the motor 33 to rotate the output shaft 40 counterclockwise (or clockwise) around the rotational axial line 43, the rotating member 35 is caused to rotate counterclockwise (or clockwise) around the rotational axial line 43. Concurrently, the roller 45 of the elastic body unit 36 smoothly turns counterclockwise 52b (or clockwise 52a) around the rotational axial line 43, transmitting a driving force to the force point section 48 of the driven member 37. During such operation, slight vibration generated by the motor 33 and transmitted to the rotating member 35 is damped absorbed in the elastic ring 53 of the roller 45, therefore the vibration transmitted to the driven member 37 becomes substantially slighter.

When the driving force is applied to the force point section 48, the force point section 48 swings clockwise 50b (or counterclockwise 50a) around the swinging axial line 51, in compliance with which the camera 31 fixed to the action point section 46 swings clockwise 34a (or counterclockwise 34b) around the swinging axial line 51. During such operation, slight vibration generated by the motor 33 and transmitted to the supporting base 41 is transmitted to the supporting shaft unit 38, however since such slight vibration is damped absorbed in the elastic bush 56 of the supporting shaft unit 38, the vibration transmitted to the driven member 37 becomes substantially slighter.

According to the foregoing, since transmission of the vibration generated by the motor 33 to the camera 31 can be prevented, images taken by the camera 31 will not shake. Also, the structure is less complicated than the prior art of FIG. 7, therefore the production cost can be reduced and a better production efficiency can be achieved.

According to the invention, since transmission of vibration generated by a motor to a camera can be prevented, images taken by the camera will not shake. Also, the driving mechanism can be manufactured at a lower production cost with a better production efficiency.

### BRIEF DESCRIPTION OF THE DRAWINGS

Other and further objects, features, and advantages of the invention will be more explicit from the following detailed description taken with reference to the drawings wherein:

FIG. 1 is a drawing showing an example of a driving mechanism according to the present invention;

FIG. 2 is a side view showing a camera equipment provided with the driving mechanism according to the Embodiment of the invention;

FIG. 3 is a fragmentary cross-sectional view taken along a direction of the arrow A of FIG. 2;

FIG. 4 is a drawing showing apart of the driving mechanism;

FIG. 5 is a cross-sectional view of an elastic body unit;

FIG. 6 is a drawing showing the first prior art; and

FIG. 7 is a drawing showing the second prior art.

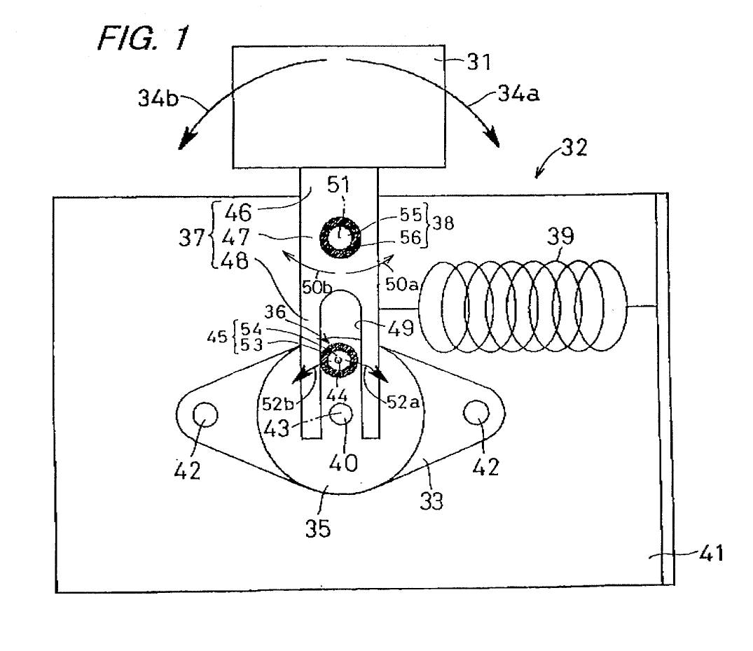

### DETAILED DESCRIPTION OF THE PREFERRED EMBODIMENTS

Now referring to the drawings, preferred embodiments of the invention are described below.

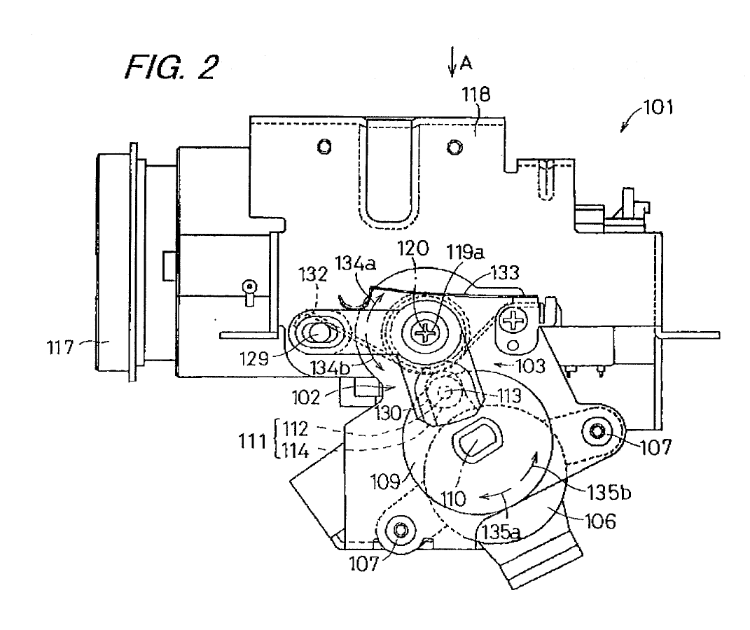

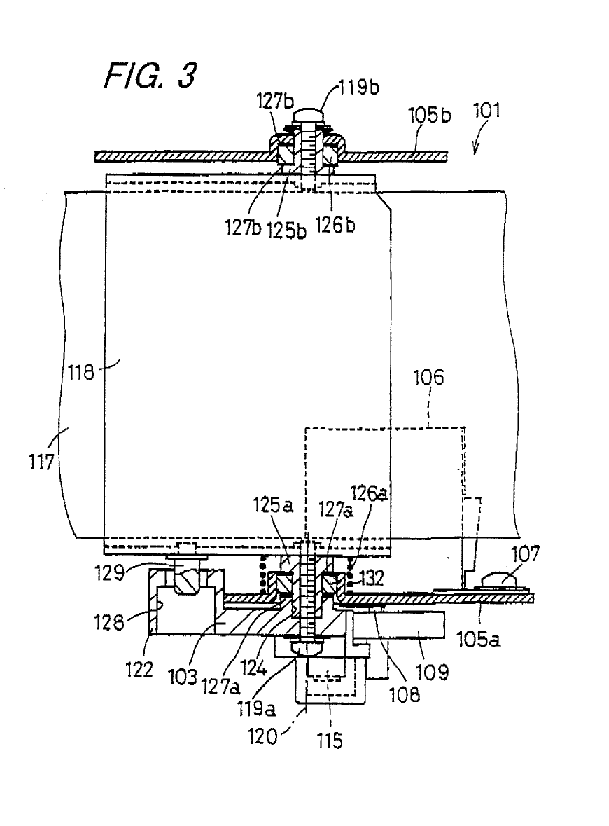

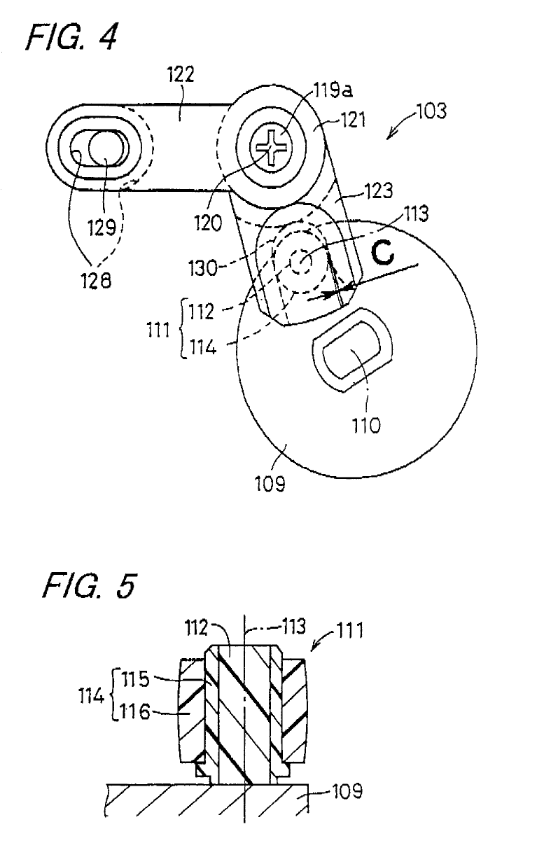

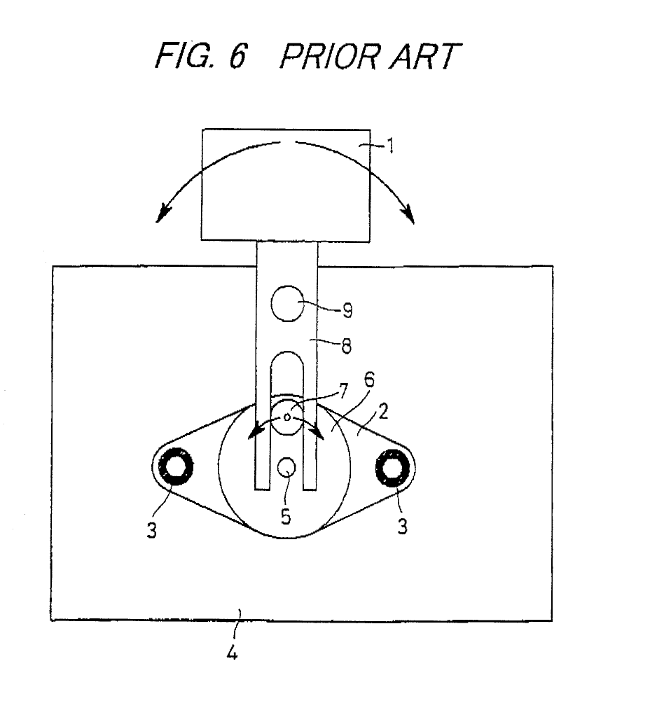

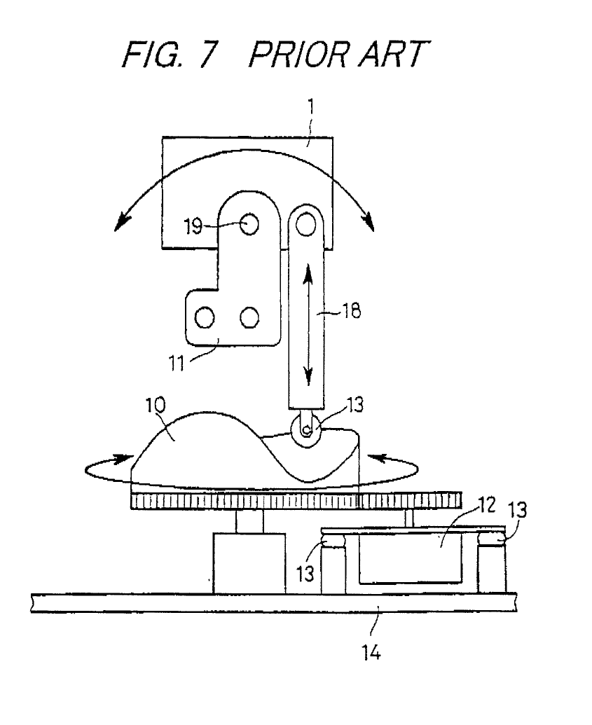

Referring to FIGS. 2 to 5, description regarding a camera equipment 101 provided with a function to vertically swing its head, suitable for use in a video conference system shall be given hereunder. FIG. 2 is a side view showing a camera equipment 101 provided with the driving mechanism 102 according to the Embodiment of the invention; FIG. 3 is a fragmentary cross-sectional view taken along a direction of the arrow A of FIG. 2; FIG. 4 is a drawing showing a part of the driving mechanism 102; and FIG. 5 is a cross-sectional view of an elastic body unit 111.

Firstly, a structure of the camera equipment 101 shall be described. A camera 117 for recording moving images is fixed to a camera fixing bracket 118 enclosing the both sides and top area of the camera 117. Supporting members 105 are attached to both sides of the camera fixing bracket 118, and the respective sides of the camera fixing bracket 118 and the supporting members 105 are fixed with fastening bolts 119a and 119b.

A motor 106 that is the rotative driving source is installed inside of one of the sidewalls 105a of the supporting member 105. The motor 106 can be embodied in a stepping motor for example, and is fixed to the sidewall 105a of the supporting member 105 with a fastening member 107 that has a high rigidity. The output shaft 108 of the motor 106 is penetrating through the sidewall 105a of the supporting member 105, and projecting outside of the supporting member 105.

A rotating member 109 of a disc shape is disposed outside of the sidewall 105a of the supporting member 105, and is rotatably supported by a shaft that is not shown around its rotational axial line 110. The rotating member 109 is caused to rotate in compliance with the rotation of the output shaft 108 of the motor 106, around the rotational axial line 110. The rotating member 109 is connected with the output shaft 108 of the motor 106, for example through a reduction gear that is not shown. Meanwhile, it is also possible to connect the output shaft 108 and the rotating member 109 coaxially, instead of providing the reduction gear.

An elastic body unit 111 is attached to the outer surface of the rotating member 109 at a position except on the rotational axial line 110. As shown in FIG. 5, the elastic body unit 111 consists of a pin 112 fixed in an erected form to the outer surface of the rotating material 109 generally in parallel with the rotational axial line 110 and a roller 114 rotatably attached to the pin 112 around its axial line 113. The roller 114 consists of an inner roller main body 115 and an outer elastic ring 116. The pin 112 and the roller main body 115 are made of a hard synthetic resin. The elastic ring 116 is made of an elastic material, for example polyoxymethylene (POM). Also, the elastic ring 116 is provided with an outer circumferential surface formed in a curvature bulging outward. In other words, the outer circumferential surface of the roller 114 has a curvature bulging outward.

As shown in FIG. 4, the driven member 103 is generally in L-shape, and is provided with a fulcrum section 121, an action point section 122 and a force point section 123. As shown in FIG. 3, a stepped shaft hole 124 is penetrating through the fulcrum section 121 in a direction of its thickness, and an end portion of a sleeve 125 is fitted into the larger diameter section of the stepped shaft hole 124. A through hole provided on the sidewall 105a of the supporting member 105 and the driven member 103 are enclosing the smaller diameter section of the sleeve 125, with an elastic bush 126 made of an elastic material such as rubber disposed therebetween. Between the elastic bush 126 and the sleeve 125, as well as between the elastic bush 126 and the fulcrum section 121, washers 127 made of resin are disposed respectively. Here, the sleeve 125, elastic bush 126, resin washers 127 and fastening bolt 119 constitute the supporting shaft unit.

An oval-shaped stepped hole 128 for inserting a pin is provided at an end portion of the action point section 122. A supporting pin 129 projecting outward from the sidewall of the camera fixing bracket 118 is inserted through the pin insertion hole 128. As a result, the camera fixing bracket 118 and the driven member 103 are combined so that a driving force can be transmitted.

A bore portion 130 is provided at the force point section 123, with an opening at its end portion and facing the supporting member 105. The roller 114 of the elastic body unit 111 is loosely inserted into the bore portion 130 with a predetermined clearance C. By securing such clearance C, the roller 114 can rotate around its axial line 113 in the bore portion 130.

When the rotating member 109 rotates around the rotational axial line 110, the roller 114 of the elastic body unit 111 contacts with a flat wall inside of the bore portion 130 of the force point section 123, causing the force point section 123 to swing around the swinging axial line 119. Concurrently the action point section 122 is caused to swing around the swinging axial line 119, further causing the camera 117 fixed to the camera fixing bracket 118 to swing around the swinging axial line 120.

The smaller diameter section of the stepped hollow sleeve 125b is inserted into a through hole formed on the other sidewall 105b of the supporting member 105, and the elastic bush 126b made of an elastic material is disposed between the larger diameter section of the sleeve 125b and the other sidewall 105b. Between the elastic bush 126b and the other sidewall 105b, as well as between the elastic bush 126b and the larger diameter section of the sleeve 125b, washers 127b made of resin are disposed respectively. Also, a lock washer 131 is provided between the fastening bolt 119 and the end portion of the sleeve 125b.

A torsion coil spring 132 is wound inside of the driven member 103, and an end portion of the torsion coil spring 132 is fixed to the sidewall 105a of the supporting member 105 while the other end portion is acting on the supporting pin 129. Also, an end portion of a plate spring 133 is fixed to the sidewall 105a of the supporting member 105, and the other end portion of the plate spring 133 is acting on the action point section 122 of the driven member 103. The torsion coil spring 132 and plate spring 133 are co-working as means for energizing. Accordingly, the driven member 103 is constantly energized with a certain force unidirectionally (counterclockwise 134b according to FIG. 2) around the swinging axial line 120. Therefore the roller 114 of the elastic body unit 111 constantly remains in contact with a wall inside of the bore portion 130 of the driven member 103. As a result, when driving the motor 106 the driven member 103 and the roller 114 will not collide with each other despite the clearance, therefore the swinging motion can be smoothly performed and generation of undesirable vibration can be prevented.

The foregoing structure is operated as follows. Driving the motor 106 to rotate its output shaft 108 causes the rotating member 109 to rotate clockwise 135a (or counterclockwise 135b) around the rotational axial line 110. Concurrently the elastic body unit 111 smoothly rotates clockwise 135a (or counterclockwise 135b) around the rotational axial line 110. During such operation, since the motor 106 is firmly fixed to the supporting base 105 with the fastening components 107 that have a high rigidity, vibration and moment generated by the motor 106 will not allow the motor 106 to change its position against the supporting base 105. Consequently, the driven member 103 can be kept from shaking during the swinging motion.

Also, slight vibration generated by the motor 106 and transmitted to the supporting base 105 is damped absorbed in the elastic bushes 126a and 126b contacting with the supporting base 105. More detailedly, the slight vibration applied to the outer circumferential portion of the elastic bushes 126a and 126b is absorbed in elastic deformation of the elastic bushes 126a and 126b while being transmitted toward the inner circumferential portion, to be sufficiently damped at the inner circumferential portion. Consequently, vibration will not be transmitted to the driven member 103 through the supporting base 105.

When the elastic body unit 111 rotates clockwise 135a (or counterclockwise 135b) around the rotational axial line 110 as described above, the roller 114 of the elastic body unit 111 contacts with a flat sidewall (or the confronting flat sidewall) inside of the bore portion 130 of the force point section 123 of the driven member 103, causing the force point section 123 to swing counterclockwise 134b (or clockwise 134a) around the swinging axial line 120. At this moment the elastic ring 116 of the roller 114 is in contact with the sidewall (or the confronting sidewall) inside of the bore portion 130 of the force point section 123. Slight vibration is generated by the motor 106 and transmitted to the pin 112 through the rotating member 109. Such slight vibration is transmitted to the inner circumferential portion of the elastic ring 116 through the roller main body 115, and absorbed in the elastic deformation of the elastic ring 116 while being transmitted toward the outer circumferential portion, to be sufficiently damped at the outer circumferential portion. Consequently, since the elastic ring 116 absorbs and damps the slight vibration, the slight vibration will not be transmitted to the driven member 103.

Swinging the force point section 123 counterclockwise 134b (or clockwise 134a) around the swinging axial line 120 as described above causes the action point section 122 to rotate counterclockwise 134b (or clockwise 134a) around the swinging axial line 120. Such swinging motion of the action point section 122 further causes the camera 117 to swing to change its position along with the supporting pin 129 of the camera fixing bracket 118 counterclockwise 134b (or clockwise 134a) around the swinging axial line 120. This is how the camera 117 vertically swings its head. According to this Embodiment of the invention, the driving mechanism 102 can make the camera 117 swing around the swinging axial line 120 over an arbitrary angle range, for example 45°.

According to the foregoing, since the driving force alone can be transmitted to the camera fixing bracket 118 without transmitting the vibration of the motor 106, images taken by the camera 117 will not shake.

Further, the driving mechanism 102 according to the invention is applicable not only to a vertical swinging motion of the camera 117, but also to a horizontal swinging motion.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A driving mechanism for transmitting a rotative force of a rotative driving source for driving an object to be driven, comprising:
a supporting base;
a rotating member that rotates relative to a rotation of an output shaft of the rotative driving source;
an elastic body unit located at a position of the rotating member which position is not on a rotational axial line thereof;
a driven member provided with a force point section with which the elastic body unit contacts, an action point section to which the object to be driven is attached, and a fulcrum section; and
a supporting shaft unit for connecting the fulcrum section of the driven member with the supporting base so that the driven member can rotate.

2. The driving mechanism of claim 1, wherein the elastic body unit is composed of:
a pin fixed to the rotating member generally in parallel with the rotational axial line of the rotating member; and
an elastic roller rotatably attached to the pin around its axial line.

3. The driving mechanism of claim 1, wherein the supporting shaft unit is elastic.

4. The driving mechanism of claim 1, further comprising:
energizing means for constantly energizing the driven member in one rotational direction.

5. The driving mechanism of claim 2, wherein the force point section of the driven member is provided with a bore portion having an opening facing outside, and
the roller of the body unit is loosely inserted through the bore portion with a clearance therebetween.

6. The driving mechanism of claim 1, wherein the object to be driven is a camera.
